(19) United States
(12) Patent Application Publication
(10) Pub. No.: US 2004/0149318 A1
(43) Pub. Date: Aug. 5, 2004

(54) Apparatus and method for cleaning a water filter

(76) Inventor: Nan-Yao Su, Davie, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/354,377

(22) Filed: Jan. 30, 2003

(51) Int. Cl. B08B 9/093

(52) U.S. Cl. 134/22.18; 134/23; 134/32; 134/137; 134/138; 134/166 R; 210/409

(57) ABSTRACT

A filter cleaning apparatus is disclosed comprising a mount for a filter element having a fluid channel, the fluid channel positioned interior to the filter element; and a plurality of fluid outlets located along the fluid channel, wherein the fluid outlets are positioned to generate a fluid flow against the filter element to rotate the filter element about the mount.

### TECHNICAL FIELD

The present invention relates generally to the cleaning of filtration components. More specifically, the present invention is directed towards the water-pressure flushing of cartridge filters, such as those filters commonly used with swimming pool filtration systems.

### BACKGROUND OF THE INVENTION

It is commonly acknowledged that the manual procedure of cleaning and flushing reusable cartridge filters, by means of hand-held high water pressure hosing, presents a laborious operation that wastes both time and water resources. Too often, this procedure proves damaging to the cartridge filter as well.

The most commonly used washable filter elements are cylindrically shaped and placed inside a filter housing provided with inlet and outlet plumbing. Water containing debris is forced from the outer surface of the filter so that debris is removed and clean water exits from the inner surface to the return. To clean the filter it is necessary to extract it from the filter housing, and either walk around the vertically positioned filter as it is being flushed out with a hose, or to rotate it to the position of the user. Furthermore, these types of washable filter elements are often elongated and have a small semi-flexible footprint. The water pressure that is required for this cleaning method stresses the pliable base and the pleated polyester fabric media of an improperly supported filter element, potentially damaging the filter element.

Filter elements are often damaged, and frequently ruined, if they are not securely supported against a lateral water pressure that can exceed 60 pounds per square inch. Poorly stabilized filter elements are typically not thoroughly cleaned under these conditions. Further, because water is sprayed from the outer filter surface to dislodge debris on the same side, larger debris may be flushed out, but small sized debris are often further pressured inside the filter crevices, and fine particles are pushed firmly between filter fabrics. Filter elements that are poorly cleaned have significantly shorter filtering cycles and require more frequent cleaning, increasing both the negative environmental effect of wasting water and the amount of labor and time spent by the user in this procedure.

Accordingly, what is lacking is a filter assembly having an effective internal water-pressurized rinsing mechanism to eliminate the complicated and problematic filter rinsing procedures commonly used to clean water filters.

### SUMMARY OF THE INVENTION

The present invention eliminates the above-mentioned needs for a filter assembly by providing a filter assembly having an effective internal water-pressurized rinsing mechanism to eliminate the complicated and problematic filter rinsing procedures commonly used to clean water filters and that allows for rotational movement of the filter element.

In accordance with the present invention, there is provided a filter cleaning apparatus including a mount for a filter element having a fluid channel, the fluid channel positioned interior to the filter element, and a plurality of fluid outlets located along the fluid channel, wherein the fluid outlets are positioned to generate a fluid flow against the filter element to rotate the filter element about the mount.

The present invention is additionally directed to a filter including a filter element having an inner filter surface, an outer filter surface, an upper cover member, and a lower cover member. The filter also includes a mount for the filter element having a fluid inlet channel, an upper cover member engagement, and a lower cover engagement. Additionally, the filter includes a plurality of fluid outlets located along the fluid inlet channel, wherein the fluid outlets are positioned to generate a fluid flow against the inner filter surface to rotate the filter element about the mount.

The present invention is further directed to a method for cleaning a water filter, the method including the steps of providing fluid flow to an interior surface of a filter, forcing the fluid flow through the filter, from said interior surface to an outer surface of the filter, and wherein the fluid flow reduces an amount of debris on the outer surface.

### BRIEF DESCRIPTION OF THE DRAWINGS

FIG. 1 is a side view illustration of the preferred embodiment of the present invention.

FIG. 2 is a top view cross-section illustration of the preferred embodiment of FIG. 1.

FIG. 3 is a side view illustration of the preferred embodiment of FIG. 1 when used in a filter housing.

### DETAILED DESCRIPTION OF THE PREFERRED EMBODIMENT

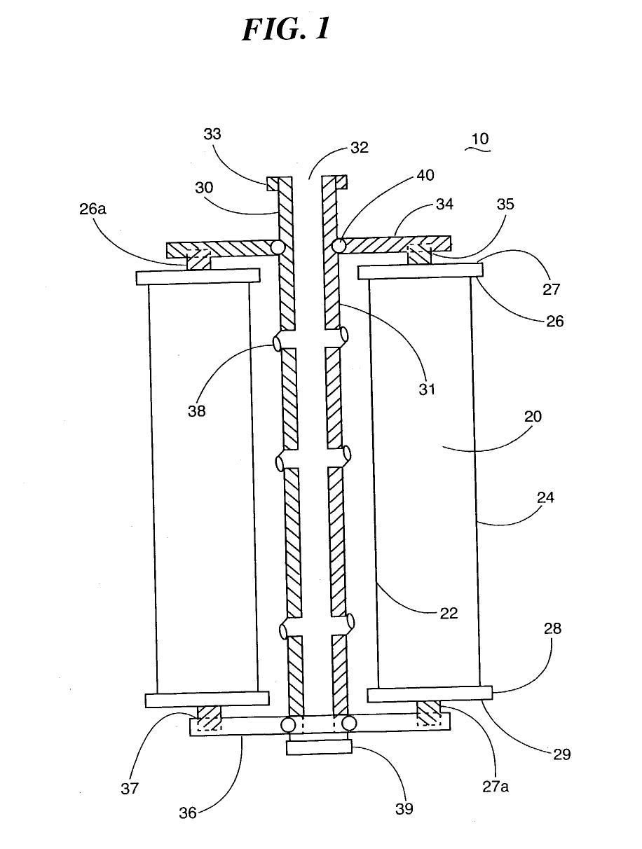

Referring now to FIG. 1, an embodiment of the present invention is illustrated as filter 10. Filter 10 includes a filter element 20 having an inner surface 22 and an outer surface 24, an upper cover member 26, and a lower cover member 28.

Filter element 20 is a porous structure that allows for the passage of water, yet does not permit the passage of dirt, detritus or other debris. Filter element 20 can be constructed of any one of a number of materials for filtering that are well know in the art, including, but not limited to, microfibers, micropores, meshes, and the like.

Filter element 20 includes inner surface 22 and outer surface 24. During the water cleaning operation, water is forced through outer surface 24 and exits inner surface 22. The forcing of water through filter element 20 from outer surface 24 to inner surface 22 filters the undesirable elements from the water. During the filter cleaning operation, the water flow is reversed so that water is forced through filter element 20 from inner surface 22 to outer surface 24 in such a manner so that debris accumulated on outer surface 24 is flushed out. Both upper cover member 26 and lower cover member 28 assist the prevention of the backflow of water and securement of filter element 20 to filter 10.

Upper cover member 26 and lower cover member 28 can be formed from a resilient material, such as a water-impermeable polymer, so as to provide a series of securement locations for filter element 20. Furthermore, upper cover member 26 includes an annular ring projection 26a that is formed and protrudes from upper surface 27 of upper cover member 26. Similarly, lower cover member 28 includes an annular ring projection 28a that is formed and protrudes from lower surface 29 of lower cover member 28. Annular ring projections 26a and 28a secure filter element 20 to mount 30.

Mount 30 can also be formed from a resilient material, such as a water-impermeable polymer or the like. Mount 30 includes a fluid inlet channel 32, an upper cover member engagement 34, and a lower cover member engagement 36. Upper cover member engagement 34 includes annular groove 35 for providing a rotatable engagement to annular ring projection 26a. Likewise, lower cover member engagement 36 includes annular groove 37 to provide a rotatable engagement to annular ring projection 28a. Although upper cover member engagement 34 and lower cover member engagement 36 can be formed from mount 30, they can be separately formed as well. In such case, upper cover member engagement 34 and lower cover member engagement 36 may be affixed to mount 30 by any one of a number of manners including, but not limited to, threaded engagements, frictional engagements, water-tight ball-bearing assembly, such as water-tight ball-bearing assembly 40, and the like.

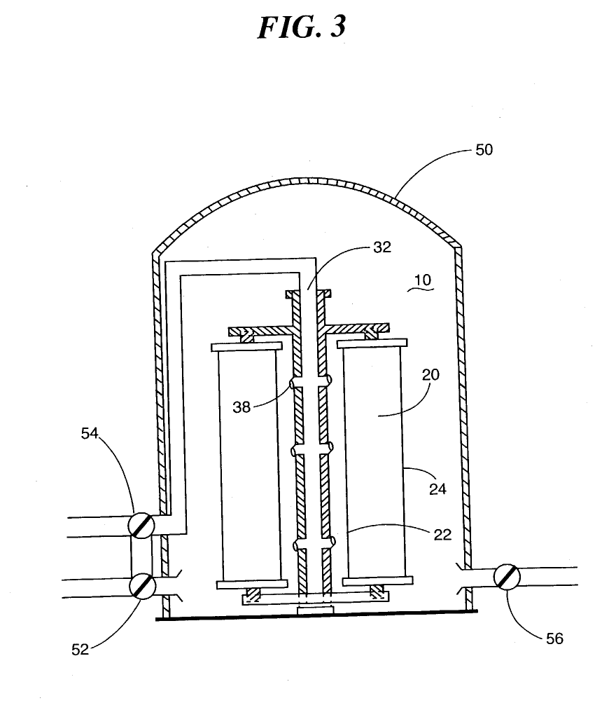

Under the water cleaning operation, pool water containing debris is directed into the filter housing via plumbing and is forced through filter element 20 from outer surface 24 to inner surface 22 before returning to the pool via fluid channel 32. Under the filter-cleaning operation a valve, such as valve 52 shown in FIG. 3, is provided in the water intake plumbing so that water is directed to enter fluid channel 32.

Fluid channel 32 is formed from wall 31 of mount 30 and extends at least as far as lower cover member 28. Wall 31 includes a plurality of fluid outlets 38 located along fluid inlet channel 32 and passing through wall 31 in a manner calculated to generate a fluid flow against inner surface 22. In the preferred embodiment of the present invention, fluid outlets 38 generate a fluid flow against inner surface 22 with force sufficient to rotate filter element 20 about mount 30. Such rotation is permitted by the engagements between annular ring projections 26a and 28a and annular grooves 35 and 37. Alternatively, if upper cover member engagement 34 and lower cover member engagement 36 are separated from mount 30, they can be affixed by a number of manners including, but not limited to, threaded engagements, frictional engagements, water-tight ball-bearing assembly 40, and the like. The rotation of filter element 20 creates a centrifugal-like force sufficient to dislodge dirt, debris and detritus attached to portions of filter element 20 proximate to wall 31. The dislodging of the undesirable materials prevents untimely clogging or reduced effectiveness of filter element 20. Such a manner of internally cleaning inner surface 22 further functions to prevent backwash of fluid into fluid inlet channel 32. Maintaining inner surface 22 and retarding the build-up of dirt, debris or detritus achieve a clearer, undisturbed fluid flow achieved from fluid inlet channel 32 through filer element 20. Because the filter cleaning operation occurs inside the enclosed filter housing, a plumbing equipped with a valve is provided so that water containing debris that was dislodged from outer surface 24 is pumped out of the filter housing.

Additionally, filter 10 can be attached to a fluid source, such as a hose (not shown), instead of utilizing the existing water pump as the power. This manual operation may be done inside the filter housing or, alternatively, the filter may be removed from the housing for cleaning. In such case, the fluid source could be secured to filter 10 at attachment region 33. Attachment region 33 may be threaded to mate with a house attachment or may frictionally engage a fluid source. Moreover, an additional attachment region 39 may also be provided in order to secure filter 20 to a structure, such as a rotatable mount or table (not shown). As with attachment region 33, attachment region 39 may be threaded to mate with the rotatable mount or table or may frictionally engage the same.

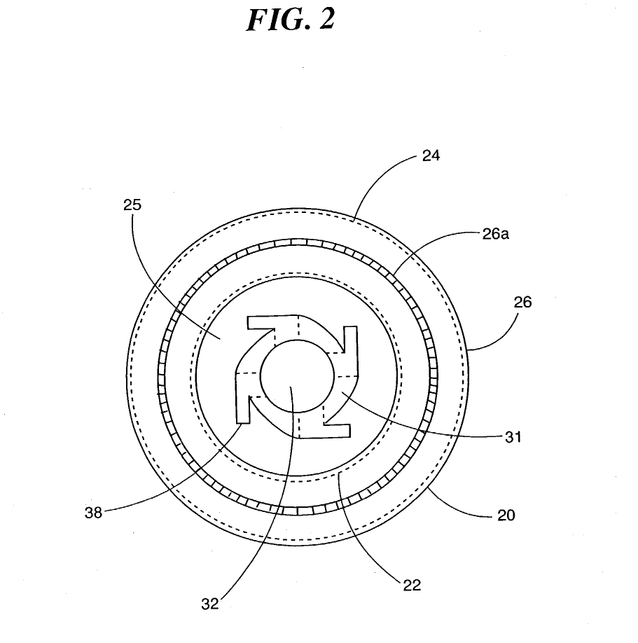

Referring now to FIG. 2, filter element 20 is shown in a top view cross section. As illustrated in FIG. 2, wall 31 of mount 30 passes through region 25, a space internal to inner surface 22 of filter element 20. In the filter-cleaning operation, fluid, such as water from a swimming pool, enters fluid inlet channel 32 and is directed out through fluid outlets 38 as a result of fluid pressure within fluid inlet channel 32. Since fluid outlets 38 have smaller diameters than that of fluid inlet channel 32, fluid exits fluid outlets 38 under higher pressure and with greater speed. The fluid enters region 25 upon exiting fluid outlets 38 and, due to the constant fluid flow into fluid inlet channel 32, is forced into fluid communication with inner surface 22 of filter element 20. Moreover, the force generated by the offset fluid outlets 38 is sufficient to cause filter element 20 to rotate about a longitudinal axis that is identical or parallel with respect to the longitudinal axis of fluid inlet channel 32. As stated above, annular ring projections, such as annular ring projection 26a of upper cover member 26, permit such rotation. It should be noted, however, that bearings, grooves, or other manners and devices can also permit such rotation and are contemplated by the present invention.

As illustrated in FIG. 3, in operation filter 10 is positioned within a housing 50. During the water-cleaning operation, valve 52 is placed in a first position that permits water from the pool containing debris to be forced through filter element 20, exiting via fluid channel 32 and valve 54 to return to the pool. Valve 54 is also placed in a first position so as to permit this fluid flow and valve 56 is closed to prevent escape of the water.

During the filter-cleaning operation, however, valve 52 is placed in a second position that shunts water to valve 54, also placed in a second position, and valve 56 is placed in an open position. Valve 54 directs the water into fluid inlet channel 32, the water then exiting fluid channel 32 through fluid outlets 38. Water exiting fluid outlets 38 is forced through filter element 20 from inner surface 22 to outer surface 24. This process dislodges debris that has become affixed to outer surface 24. Water exiting outer surface 24 exits filter housing 50 via valve 56.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

What is claimed is:

1. A filter cleaning apparatus comprising:
a mount for a filter element having a fluid channel, said fluid channel positioned interior to said filter element; and
a plurality of fluid outlets located along said fluid channel, wherein said fluid outlets are positioned to generate a fluid flow against said filter element to rotate said filter element about said mount.

2. A filter comprising:
a filter element having an inner filter surface;
a mount for said filter element having a fluid channel, said fluid channel positioned interior to said inner filter surface;
a plurality of fluid outlets located along said fluid channel, wherein said fluid outlets are positioned to generate a fluid flow against said inner filter surface to rotate said filter element about said mount.

3. The filter according to claim 1 wherein said filter element operatively engages an upper cover member.

4. The filter according to claim 1 wherein said filter element operatively engages a lower cover member.

5. The filter according to claim 2 wherein said mount incorporates an upper cover member engagement for operative engagement of said upper cover member.

6. The filter according to claim 2 wherein said mount incorporates a lower cover engagement for operative engagement of said lower cover member.

7. A method for cleaning a water filter, said method comprising the steps of:
providing fluid flow to an interior surface of a filter;
forcing said fluid flow through said filter, from said interior surface to an outer surface of said filter, and
wherein said fluid flow reduces an amount of debris on said outer surface.
